(19) United States
(12) Patent Application Publication
(10) Pub. No.: US 2020/0048506 A1
(43) Pub. Date: Feb. 13, 2020

(54) PRESSURE-SENSITIVE ADHESIVE TAPE

(71) Applicant: NITTO DENKO CORPORATION, Osaka (JP)

(72) Inventors: Naoaki HIGUCHI, Ibaraki-shi (JP); Masataka NISHIWAKI, Ibaraki-shi (JP); Yasushi BUZOJIMA, Ibaraki-shi (JP)

(73) Assignee: NITTO DENKO CORPORATION, Osaka (JP)

(21) Appl. No.: 16/503,721

(22) Filed: Jul. 5, 2019

(30) Foreign Application Priority Data
Aug. 8, 2018 (JP) 2018-149560

(51) Int. Cl. C09J 7/38; C09J 7/29

(52) U.S. Cl. CPC C09J 7/385; C09J 7/29; C09J 2203/326; C09J 2475/006; C09J 2433/00; C09J 2467/006

(57) ABSTRACT

Provided is a pressure-sensitive adhesive tape capable of preventing an increase in internal pressure when used for, for example, forming a closed space. The pressure-sensitive adhesive tape is a pressure-sensitive adhesive tape, including, in this order: a first pressure-sensitive adhesive layer; an intermediate layer; and a second pressure-sensitive adhesive layer, the pressure-sensitive adhesive tape having at least one through-hole that penetrates through the pressure-sensitive adhesive tape in a plane direction thereof.

This application claims priority under 35 U.S.C. Section 119 to Japanese Patent Application No. 2018-149560 filed on Aug. 88, 2018, which is herein incorporated by references.

### BACKGROUND OF THE INVENTION

### 1. Field of the Invention

The present invention relates to a pressure-sensitive adhesive tape.

### 2. Description of the Related Art

An adhesive, a pressure-sensitive adhesive, or a pressure-sensitive adhesive tape is generally used for bonding of various constituent members of many electronic devices, such as a personal computer, a tablet, and a smartphone (for example, Japanese Patent Application Laid-open No. 2018-087334). In an inside of such electronic device, a closed space is sometimes formed due to the bonding of various members.

During use of such electronic device as described above, heat is generated in the inside of the device. As a result, a temperature in the closed space inside the electronic device is increased, leading to an increase in pressure in the closed space. Accordingly, there is a risk in that the members forming the closed space may be affected by the internal pressure, resulting in damage to the members, occurrence of a defect, or a failure to sufficiently express a function to be expressed.

### SUMMARY OF THE INVENTION

An object of the present invention is to provide a pressure-sensitive adhesive tape capable of preventing an increase in internal pressure when used for, for example, forming a closed space.

According to one embodiment of the present invention, there is provided a pressure-sensitive adhesive tape, including, in this order: a first pressure-sensitive adhesive layer; an intermediate layer; and a second pressure-sensitive adhesive layer, the pressure-sensitive adhesive tape having at least one through-hole that penetrates through the pressure-sensitive adhesive tape in a plane direction thereof.

In one embodiment, the through-hole is arranged so as to penetrate through the pressure-sensitive adhesive tape in a widthwise direction thereof.

In one embodiment, the intermediate layer includes a printed layer formed by printing.

In one embodiment, the pressure-sensitive adhesive tape further includes a base material layer between the printed layer and the second pressure-sensitive adhesive layer, wherein the printed layer is laminated with the base material layer, and wherein the through-hole is defined by a printed pattern of the printed layer, the first pressure-sensitive adhesive layer, and the base material layer.

In one embodiment, the intermediate layer has a thickness of from 0.1 μm to 100 μm.

In one embodiment, the pressure-sensitive adhesive tape has a total thickness of from 1 μm to 500 μm.

According to the present invention, the pressure-sensitive adhesive tape capable of preventing an increase in internal pressure when used for, for example, forming the closed space, can be provided.

### BRIEF DESCRIPTION OF THE DRAWINGS

FIG. 1A, FIG. 1B, FIG. 1C, and FIG. 1D are each a schematic plan view for illustrating a widthwise direction serving as the direction of a through-hole.

FIG. 2A, FIG. 2B, FIG. 2C, and FIG. 2D are each a schematic plan view for illustrating a lengthwise direction serving as the direction of a through-hole.

FIG. 3 is a schematic perspective view of a pressure-sensitive adhesive tape according to one embodiment of the present invention.

FIG. 4 is a schematic cross-sectional view of the pressure-sensitive adhesive tape according to one embodiment of the present invention.

FIG. 5 is a schematic cross-sectional view of a pressure-sensitive adhesive tape according to one embodiment of the present invention.

FIG. 6 is a schematic cross-sectional view of a pressure-sensitive adhesive tape according to one embodiment of the present invention.

FIG. 7A and FIG. 7B are a schematic plan view of a frame-shaped tape sample for leakage property evaluation and a schematic perspective view of an evaluation sample.

FIG. 8 is a schematic perspective view of a laminate (1).

FIG. 9 is a schematic perspective view of a laminate (2).

### DESCRIPTION OF THE EMBODIMENTS

As used herein, the term “(meth)acrylic” means acrylic and/or methacrylic, the term “(meth)acrylate” means acrylate and/or methacrylate, and the term “Cx-y alkyl ester” means an ester of an alkyl group having x to y carbon atoms.

### «Pressure-sensitive Adhesive Tape»

A pressure-sensitive adhesive tape of the present invention includes a first pressure-sensitive adhesive layer, an intermediate layer, and a second pressure-sensitive adhesive layer in the stated order. The pressure-sensitive adhesive tape of the present invention may include any appropriate other layer as long as the pressure-sensitive adhesive tape includes the first pressure-sensitive adhesive layer, the intermediate layer, and the second pressure-sensitive adhesive layer in the stated order and to the extent that the effect of the present invention is not impaired. The number of other layers may be only one, or may be two or more.

Typical examples of the other layer include a base material layer and a release liner.

The pressure-sensitive adhesive tape of the present invention has at least one through-hole that penetrates through the pressure-sensitive adhesive tape in a plane direction thereof. The number of through-holes only needs to be at least one, and may be appropriately set depending on purposes and the like.

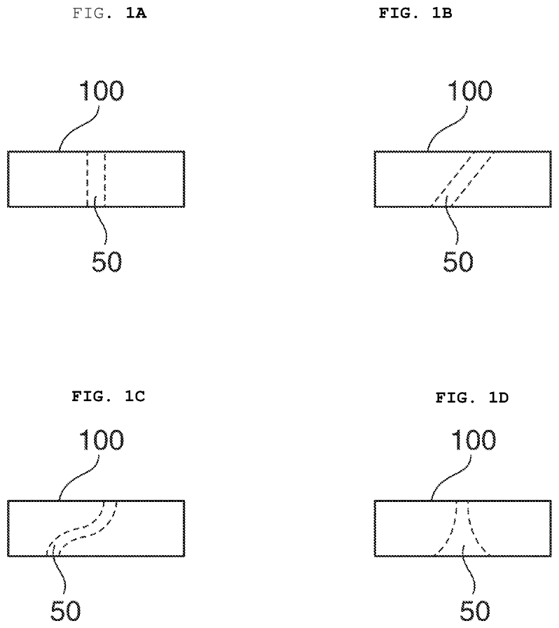

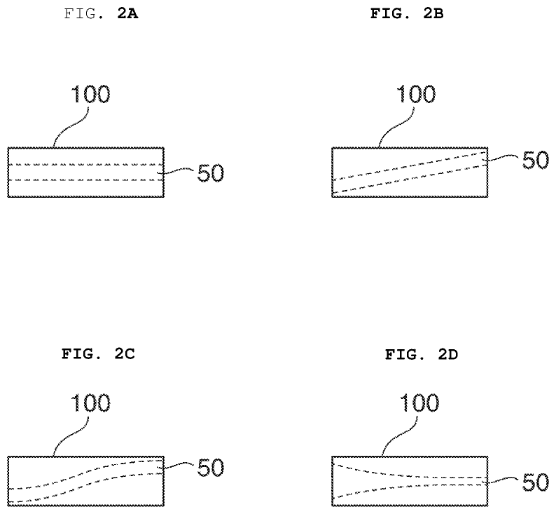

The through-hole may be a through-hole in any direction as long as the through-hole penetrates through the pressure-sensitive adhesive tape in the plane direction thereof. The plane direction serving as the direction of the through-hole is specifically at least one kind selected from: a direction formed by a through-hole having an opening on each of both end surfaces of the pressure-sensitive adhesive tape along a lengthwise direction thereof; and a direction formed by a through-hole having an opening on each of both end surfaces of the pressure-sensitive adhesive tape along a widthwise direction thereof. Examples of the plane direction serving as the direction of the through-hole include the widthwise direction of the pressure-sensitive adhesive tape and the lengthwise direction of the pressure-sensitive adhesive tape. As illustrated in the schematic plan views of FIG. 1A, FIG. 1B, FIG. 1C, and FIG. 1D, examples of the widthwise direction serving as the direction of the through-hole include the following directions in the case of a through-hole having an opening on each of both the end surfaces along the lengthwise direction: a direction giving a through-hole 50 that penetrates through a pressure-sensitive adhesive tape 100 in a direction exactly parallel to the widthwise direction thereof (FIG. 1A); a direction giving the through-hole 50 that penetrates through the pressure-sensitive adhesive tape 100 in a direction forming a constant angle with the widthwise direction thereof (FIG. 1B); and directions giving the through-hole 50 that penetrates through the pressure-sensitive adhesive tape 100 via a plurality of directions including the widthwise direction thereof (FIG. 1C and FIG. 1D). In addition, as illustrated in the schematic plan views of FIG. 2A, FIG. 2B, FIG. 2C, and FIG. 2D, examples of the lengthwise direction serving as the direction of the through-hole include the following directions in the case of a through-hole having an opening on each of both the end surfaces along the widthwise direction: a direction giving a through-hole 50 that penetrates through a pressure-sensitive adhesive tape 100 in a direction exactly parallel to the lengthwise direction thereof (FIG. 2A); a direction giving the through-hole 50 that penetrates through the pressure-sensitive adhesive tape 100 in a direction forming a constant angle with the lengthwise direction thereof (FIG. 2B); and directions giving the through-hole 50 that penetrates through the pressure-sensitive adhesive tape 100 via a plurality of directions including the lengthwise direction thereof (FIG. 2C and FIG. 2D).

The through-hole is preferably arranged so as to penetrate through the pressure-sensitive adhesive tape in the widthwise direction thereof from the viewpoint of, for example, the ease of design.

Any appropriate shape may be adopted as the shape of the through-hole to the extent that the effect of the present invention is not impaired.

The size of each of the openings of the through-hole may be appropriately set depending on purposes as long as the size fits into the end surface of the pressure-sensitive adhesive tape of the present invention.

The total thickness of the pressure-sensitive adhesive tape of the present invention may be appropriately set depending on purposes. The pressure-sensitive adhesive tape of the present invention can be designed to be thin, and hence, when the pressure-sensitive adhesive tape of the present invention is used for, for example, forming a thin closed space, the total thickness of the pressure-sensitive adhesive tape of the present invention is preferably from 1 μm to 500 μm, more preferably from 1 μm to 300 μm, still more preferably from 1 μm to 200 μm, particularly preferably from 1 μm to 100 μm.

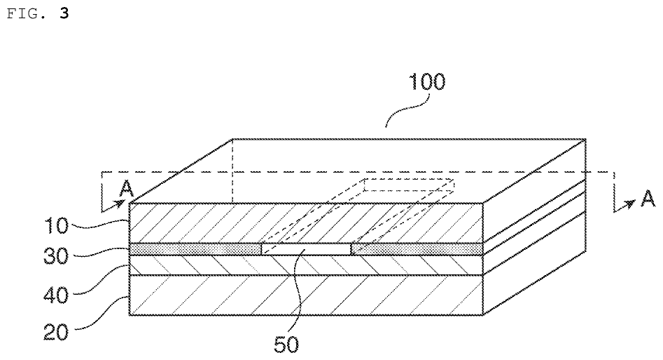

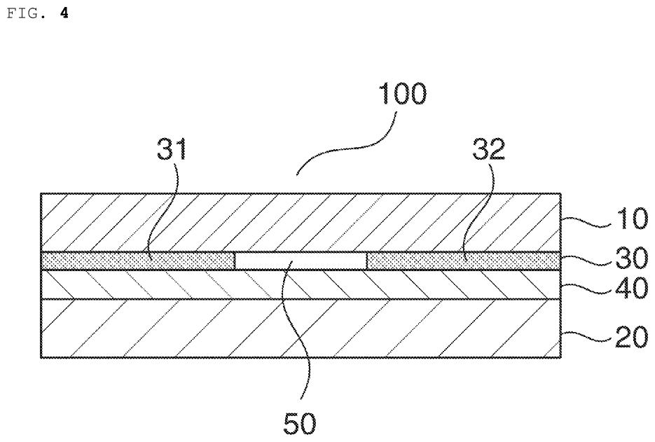

FIG. 3 is a schematic perspective view of a pressure-sensitive adhesive tape according to one embodiment of the present invention. FIG. 4 is a schematic cross-sectional view taken along the line A-A of FIG. 3. In FIG. 3 and FIG. 4, the pressure-sensitive adhesive tape 100 includes a first pressure-sensitive adhesive layer 10, an intermediate layer 30, a base material layer 40, and a second pressure-sensitive adhesive layer 20 in the stated order, and has the through-hole 50 that penetrates through the pressure-sensitive adhesive tape in the widthwise direction thereof.

In the pressure-sensitive adhesive tape illustrated in FIG. 3 and FIG. 4, the through-hole 50 is defined by the pattern of the intermediate layer 30, the first pressure-sensitive adhesive layer 10, and the base material layer 40. Specifically, the through-hole 50 is defined by: a first portion 31 and a second portion 32 of the intermediate layer 30 having a pattern forming the through-hole in the widthwise direction; the first pressure-sensitive adhesive layer 10; and the base material layer 40.

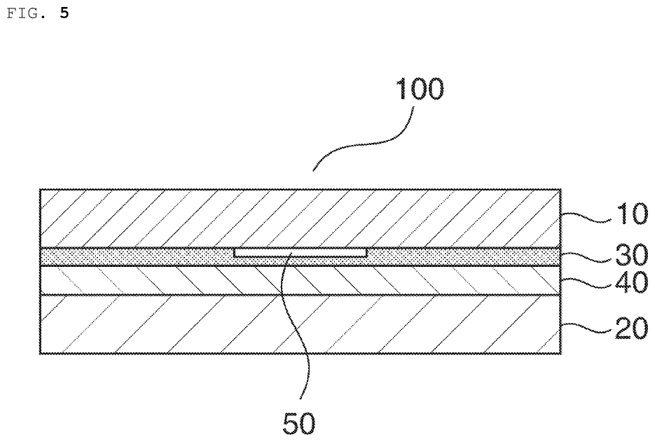

The pressure-sensitive adhesive tape of the present invention may also adopt an embodiment in which, as illustrated in the schematic cross-sectional view of FIG. 5, the pressure-sensitive adhesive tape includes the first pressure-sensitive adhesive layer 10, the intermediate layer 30, the base material layer 40, and the second pressure-sensitive adhesive layer 20 in the stated order, and has the through-hole 50 that penetrates through the pressure-sensitive adhesive tape in the widthwise direction thereof, wherein the through-hole 50 is defined by the pattern of the intermediate layer 30 and the first pressure-sensitive adhesive layer 10. Specifically, the through-hole 50 is defined by the intermediate layer 30 having a pattern forming the through-hole 50 in the widthwise direction and the first pressure-sensitive adhesive layer 10.

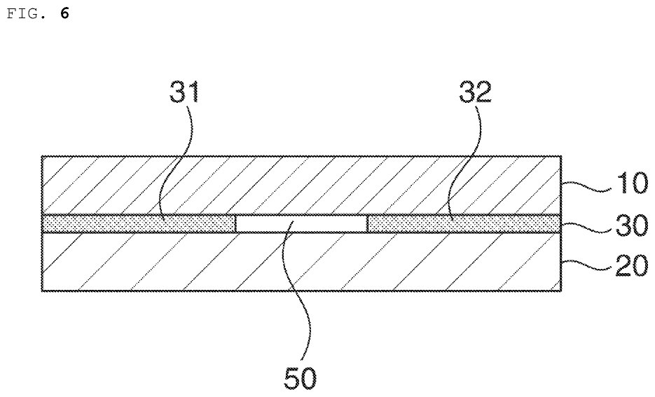

The pressure-sensitive adhesive tape of the present invention may also adopt an embodiment in which, as illustrated in the schematic cross-sectional view of FIG. 6, the pressure-sensitive adhesive tape includes the first pressure-sensitive adhesive layer 10, the intermediate layer 30, and the second pressure-sensitive adhesive layer 20 in the stated order, and has the through-hole 50 that penetrates through the pressure-sensitive adhesive tape in the widthwise direction thereof. In the embodiment illustrated in FIG. 6, the through-hole 50 is defined by the pattern of the intermediate layer 30, the first pressure-sensitive adhesive layer 10, and the second pressure-sensitive adhesive layer 20. Specifically, the through-hole 50 is defined by: the first portion 31 and the second portion 32 of the intermediate layer 30 having a pattern forming the through-hole 50 in the widthwise direction; the first pressure-sensitive adhesive layer 10; and the second pressure-sensitive adhesive layer 20.

### <Intermediate Layer>

The intermediate layer preferably has a pattern forming at least one through-hole in the plane direction. The pattern forming at least one through-hole in the plane direction may be appropriately set depending on purposes. Preferred examples of the pattern forming at least one through-hole in the plane direction include such patterns as illustrated in FIG. 3, FIG. 4, FIG. 5, and FIG. 6.

Any appropriate material may be adopted as a material for the intermediate layer to the extent that the effect of the present invention is not impaired. Examples of such material include a polyurethane-based resin, a phenol-based resin, an epoxy-based resin, a polyamide-based resin, a urea melamine-based resin, a silicone-based resin, a polysilazane-based resin, a fluorine-based resin, a phenoxy resin, a methacrylic resin, an acrylic resin, an acryl-urethane-based resin, an acryl-styrene-based resin, a polyarylate resin, a polyester-based resin, a polyolefin-based resin, a polystyrene-based resin, polyvinyl chloride, a vinyl chloride-vinyl acetate copolymer, polyvinyl acetate, polyvinylidene chloride, polycarbonate, celluloses, and polyacetal. Those resins may be one kind or two or more kinds of resins selected from various types of resins, such as a thermosetting resin, a UV-curable resin, an electron beam-curable resin, and a two-component resin.

The intermediate layer may contain various additives, such as a filler, an age resister, an antioxidant, a UV absorber, a cross-linking agent, a lubricant, a colorant (e.g., a pigment or a dye), an antistatic agent, a fluidity modifier (e.g., a thixotropic agent or a thickener), and a film forming aid, as required.

For example, in the case of the embodiment of FIG. 3, FIG. 4, or FIG. 5, the intermediate layer is preferably a printed layer formed by printing. When the intermediate layer is the printed layer formed by printing, a pattern forming any appropriate number of through-holes of any appropriate sizes and shapes in the plane direction can be easily formed.

When the intermediate layer is the printed layer formed by printing, any appropriate formation method may be adopted as a formation method therefor to the extent that the effect of the present invention is not impaired. An example of such formation method is a method involving performing printing on the surface of a layer adjacent to the intermediate layer in the pressure-sensitive adhesive tape. In the case of the pressure-sensitive adhesive tape illustrated in FIG. 3, FIG. 4, or FIG. 5, a specific example of the method is a method involving performing printing on the surface of the base material layer 40.

When the printed layer is formed on the surface of the base material layer, the through-hole is defined by the printed pattern of the printed layer, the first pressure-sensitive adhesive layer, and the base material layer in such embodiment as illustrated in FIG. 3 and FIG. 4, and is defined by the printed pattern of the printed layer and the first pressure-sensitive adhesive layer in such embodiment as illustrated in FIG. 5.

When the openings of the through-hole each have a quadrilateral shape as illustrated in FIG. 3, FIG. 4, FIG. 5, or FIG. 6, the width (length in the plane direction) of each of the openings of the through-hole is preferably from 1 μm to 100,000 μm, more preferably from 5 μm to 10,000 μm, still more preferably from 10 μm to 5,000 μm, particularly preferably from 100 μm to 1,000 μm in order that the effect of the present invention can be expressed to a greater degree.

When the openings of the through-hole each have a quadrilateral shape as illustrated in FIG. 3, FIG. 4, FIG. 5, or FIG. 6, the height (length in a thickness direction) of each of the openings of the through-hole is preferably from 0.1 μm to 100 μm, more preferably from 0.5 μm to 80 μm, still more preferably from 1 μm to 60 μm, particularly preferably from 1 μm to 40 μm in order that the effect of the present invention can be expressed to a greater degree.

The thickness of the intermediate layer may be appropriately set depending on purposes. The pressure-sensitive adhesive tape of the present invention can be designed to be thin, and hence, when the pressure-sensitive adhesive tape of the present invention is used for, for example, forming a thin closed space, the thickness of the intermediate layer is preferably from 0.1 μm to 100 μm, more preferably from 0.5 μm to 80 μm, still more preferably from 1 μm to 60 μm, particularly preferably from 1 μm to 40 μm.

### <Base Material Layer>

Any appropriate material may be adopted as a material for the base material layer to the extent that the effect of the present invention is not impaired. Examples of such material include a resin film, paper, fabric, a rubber sheet, a foam sheet, a metallic foil, and a composite thereof.

Examples of the resin film include: a polyolefin film, such as polyethylene, polypropylene, or an ethylene-propylene copolymer; a polyester film, such as polyethylene terephthalate (PET); a vinyl chloride resin film; a vinyl acetate resin film; a polyimide resin film; a polyamide resin film; a fluororesin film; and a cellophane.

Examples of the paper include Japanese paper, craft paper, glassine paper, high-quality paper, synthetic paper, and top coat paper.

Examples of the fabric include woven fabric and non-woven fabric of a fibrous material. Examples of the fibrous material include cotton, staple fiber, manila hemp, pulp, rayon, acetate fiber, polyester fiber, polyvinyl alcohol fiber, polyamide fiber, and polyolefin fiber.

Examples of the rubber sheet include a natural rubber sheet and a butyl rubber sheet.

Examples of the foam sheet include a polyurethane foam sheet and a polychloroprene rubber foam sheet.

Examples of the metallic foil include an aluminum foil and a copper foil.

The thickness of the base material layer may be appropriately set depending on purposes. The pressure-sensitive adhesive tape of the present invention can be designed to be thin, and hence, when the pressure-sensitive adhesive tape of the present invention is used for, for example, forming a thin closed space, the thickness of the base material layer is preferably from 1 μm to 100 μm, more preferably from 1 μm to 80 μm, still more preferably from 1 μm to 50 μm, particularly preferably from 1 μm to 30 μm.

### <First Pressure-Sensitive Adhesive Layer and Second Pressure-Sensitive Adhesive Layer>

The first pressure-sensitive adhesive layer and the second pressure-sensitive adhesive layer may be pressure-sensitive adhesive layers of the same kind, or may be pressure-sensitive adhesive layers of different kinds. Any appropriate pressure-sensitive adhesive may be adopted as a pressure-sensitive adhesive for forming each of the first pressure-sensitive adhesive layer and the second pressure-sensitive adhesive layer to the extent that the effect of the present invention is not impaired. The pressure-sensitive adhesives may be used alone or in combination thereof.

Examples of the pressure-sensitive adhesive include an acrylic pressure-sensitive adhesive, a silicone-based pressure-sensitive adhesive, a rubber-based pressure-sensitive adhesive, a polyamide-based pressure-sensitive adhesive, a polyester-based pressure-sensitive adhesive, an ethylene-vinyl acetate copolymer-based pressure-sensitive adhesive, and a polyurethane-based pressure-sensitive adhesive. Of those, an acrylic pressure-sensitive adhesive is preferred.

The pressure-sensitive adhesive layers may each be formed by, for example, applying a solution or dispersion liquid in which the pressure-sensitive adhesive is dissolved or dispersed in an organic liquid medium or an aqueous liquid medium to one surface of a support in the form of a layer, and heating the resultant to dry and remove the organic liquid medium or the aqueous liquid medium. Any appropriate application method may be adopted as a method for the applying. Specific examples of such application method include roll coating, kiss-roll coating, gravure coating, reverse coating, roll brushing, spray coating, dip roll coating, bar coating, knife coating, air knife coating, curtain coating, lip coating, and extrusion coating with a die coater or the like. A heating temperature is preferably from 40° C. to 200° C., more preferably from 50° C. to 180° C., still more preferably from 70° C. to 170° C. When the heating temperature is set to fall within the above-mentioned range, a pressure-sensitive adhesive layer having excellent pressure-sensitive adhesive properties can be obtained. Any appropriate period of time may be adopted as a drying time. Such drying time is preferably from 5 seconds to 20 minutes, more preferably from 5 seconds to 10 minutes, still more preferably from 10 seconds to 5 minutes. When the drying time is set to fall within the above-mentioned range, a pressure-sensitive adhesive layer having excellent pressure-sensitive adhesive properties can be obtained.

### (Acrylic Pressure-Sensitive Adhesive)

The acrylic pressure-sensitive adhesive preferably contains, as a base polymer, an acrylic polymer containing a constituent unit derived from a (meth)acrylic acid alkyl ester as a main monomer unit. The acrylic polymer may adopt any appropriate structure, such as a random copolymer, a block copolymer, or a graft copolymer. The acrylic pressure-sensitive adhesives may be used alone or in combination thereof.

Examples of the (meth)acrylic acid alkyl ester include (meth)acrylic acid alkyl esters each having 1 to 20 carbon atoms, such as methyl (meth)acrylate, ethyl (meth)acrylate, propyl (meth)acrylate, n-butyl (meth)acrylate, isobutyl (meth)acrylate, sec-butyl (meth)acrylate, t-butyl (meth)acrylate, hexyl (meth)acrylate, 2-ethylhexyl (meth)acrylate, cyclohexyl (meth)acrylate, t-butylcyclohexyl (meth)acrylate, isoamyl (meth)acrylate, n-pentyl (meth)acrylate, isopentyl (meth)acrylate, cyclopentyl (meth)acrylate, n-octyl (meth)acrylate, isooctyl (meth)acrylate, cyclooctyl (meth)acrylate, n-nonyl (meth)acrylate, isononyl (meth)acrylate, n-decyl (meth)acrylate, isodecyl (meth)acrylate, n-dodecyl (meth)acrylate, undecyl (meth)acrylate, isoundecyl (meth)acrylate, isomyristyl (meth)acrylate, n-tridecyl (meth)acrylate, n-tetradecyl (meth)acrylate, n-pentadecyl (meth)acrylate, n-octadecyl (meth)acrylate, n-nonadecyl (meth)acrylate, and n-eicosyl (meth)acrylate. Of such (meth)acrylic acid alkyl esters each having 1 to 20 carbon atoms, a (meth)acrylic acid alkyl ester having 1 to 12 carbon atoms is preferred, and a (meth)acrylic acid alkyl ester having 1 to 8 carbon atoms is more preferred. The (meth)acrylic acid alkyl esters may be used alone or in combination thereof.

The content ratio of the constituent unit derived from the (meth)acrylic acid alkyl ester to all monomer units constituting the acrylic polymer is preferably from 50 wt % to 99.9 wt %, more preferably from 70 wt % to 99 wt %.

The acrylic polymer may contain a constituent unit derived from another monomer copolymerizable with the (meth)acrylic acid alkyl ester. Examples of such other monomer include: carboxy group-containing monomers, such as acrylic acid, methacrylic acid, carboxyethyl (meth)acrylate, carboxypentyl (meth)acrylate, itaconic acid, maleic acid, fumaric acid, and crotonic acid; hydroxy group-containing monomers, such as 2-hydroxyethyl (meth)acrylate, 2-hydroxypropyl (meth)acrylate, 4-hydroxybutyl (meth)acrylate, 2-hydroxyhexyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-hydroxymethylcyclohexyl)methyl acrylate, N-methylol (meth)acrylamide, N-hydroxy (meth)acrylamide, vinyl alcohol, allyl alcohol, 2-hydroxyethyl vinyl ether, 4-hydroxybutyl vinyl ether, diethylene glycol monovinyl ether, and (4-hydroxymethylcyclohexyl)methyl methacrylate; sulfo group-containing monomers, such as styrenesulfonic acid, allylsulfonic acid, 2-(meth)acrylamido-2-methylpropanesulfonic acid, (meth)acrylamidopropanesulfonic acid, sulfopropyl (meth)acrylate, and (meth)acryloyloxynaphthalenesulfonic acid; phosphate group-containing monomers, such as 2-hydroxyethylacryloyl phosphate; (N-substituted) amide-based monomers, such as (meth)acrylamide, N,N-dimethyl (meth)acrylamide, N-butyl (meth)acrylamide, N-methylol (meth)acrylamide, and N-methylolpropane (meth)acrylamide; aminoalkyl (meth)acrylate-based monomers, such as aminoethyl (meth)acrylate, N,N-dimethylaminoethyl (meth)acrylate, t-butylaminoethyl (meth)acrylate; alkoxyalkyl (meth)acrylate-based monomers; maleimide-based monomers, such as N-cyclohexylmaleimide, N-isopropylmaleimide, N-laurylmaleimide, and N-phenylmaleimide; itaconimide-based monomers, such as N-methylitaconimide, N-ethylitaconimide, N-butylitaconimide, N-octylitaconimide, N-2-ethylhexylitaconimide, N-cyclohexylitaconimide, and N-laurylitaconimide; succinimide-based monomers, such as N-(meth)acryloyloxymethylene succinimide, N-(meth)acryloyl-6-oxyhexamethylene succinimide, and N-(meth)acryloyl-8-oxyoctamethylene succinimide; vinyl-based monomers, such as vinyl acetate, vinyl propionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxylic acid amides, styrene, α-methylstyrene, and N-vinylcaprolactam; cyano acrylate-based monomers, such as acrylonitrile and methacrylonitrile; epoxy group-containing acrylic monomers, such as glycidyl (meth)acrylate; glycol-based acrylate monomers, such as polypropylene glycol (meth)acrylate, methoxyethyl glycol (meth)acrylate, and methoxypolypropylene glycol (meth)acrylate; acrylate-based monomers each having a heterocycle, a halogen atom, a silicon atom, or the like, such as tetrahydrofurfuryl (meth)acrylate, fluorinated (meth)acrylate, and silicone (meth)acrylate; polyfunctional monomers, such as hexanediol di(meth)acrylate, (poly)ethylene glycol di(meth)acrylate, polypropylene glycol di(meth)acrylate, neopentyl glycol di(meth)acrylate, pentaerythritol di(meth)acrylate, trimethylolpropane tri(meth)acrylate, pentaerythritol tri(meth)acrylate, dipentaerythritol hexa(meth)acrylate, epoxy acrylate, polyester acrylate, urethane acrylate, divinylbenzene, butyl di(meth)acrylate, and hexyl di(meth)acrylate; olefin-based monomers, such as isoprene, dibutadiene, and isobutylene; and vinyl ether-based monomers, such as vinyl ether. Of those, a carboxy group-containing monomer or a hydroxy group-containing monomer is preferred as the other monomer. The other monomers may be used alone or in combination thereof.

The acrylic polymer may be produced by any appropriate method to the extent that the effect of the present invention is not impaired. A preferred example of such method is a production method involving polymerizing the monomer(s) serving as raw material according to any appropriate polymerization mode. Examples of such polymerization mode include various kinds of radical polymerization, such as solution polymerization, bulk polymerization, and emulsion polymerization. Any appropriate additive components may be adopted as additive components, such as a polymerization initiator, a chain transfer agent, and an emulsifier, which may be generally used in such polymerization mode, to the extent that the effect of the present invention is not impaired. In addition, any appropriate usage amount may be adopted as the usage amount of any such additive component to the extent that the effect of the present invention is not impaired.

The weight-average molecular weight of the acrylic polymer may be controlled on the basis of the usage amounts of the polymerization initiator, the chain transfer agent, and the like, reaction conditions, and the like.

Examples of the polymerization initiator include: azo-based initiators, such as 2,2′-azobisisobutyronitrile, 2,2′-azobis(2-amidinopropane) dihydrochloride, 2,2′-azobis[2-(5-methyl-2-imidazolin-2-yl)propane] dihydrochloride, 2,2′-azobis(2-methylpropionamidine) disulfate, 2,2′-azobis(N,N′-dimethyleneisobutylamidine), and 2,2′-azobis[N-(2-carboxyethyl)-2-methylpropionamidine] hydrate (VA-057 manufactured by Wako Pure Chemical Industries Ltd.); persulfates, such as potassium persulfate and ammonium persulfate; peroxide-based initiators, such as di(2-ethylhexyl) peroxydicarbonate, di(4-t-butylcyclohexyl) peroxydicarbonate, di-sec-butyl peroxydicarbonate, t-butyl peroxyneodecanoate, t-hexyl peroxypivalate, t-butyl peroxypivalate, dilauroyl peroxide, di-n-octanoyl peroxide, 1,1,3,3-tetramethylbutyl peroxy-2-ethylhexanoate, di(4-methylbenzoyl) peroxide, dibenzoyl peroxide, t-butyl peroxyisobutyrate, 1,1-di(t-hexylperoxy)cyclohexane, t-butyl hydroperoxide, and hydrogen peroxide; a combination of a persulfate and sodium hydrogen sulfite; and redox-based initiators each obtained by combining a peroxide and a reducing agent, such as a combination of a peroxide and sodium ascorbate.

The polymerization initiators may be used alone or in combination thereof.

The usage amount of the polymerization initiator is preferably from 0.005 part by weight to 1 part by weight, more preferably from 0.02 part by weight to 0.5 part by weight with respect to 100 parts by weight of all monomers.

Examples of the chain transfer agent include lauryl mercaptan, glycidyl mercaptan, mercaptoacetic acid, 2-mercaptoethanol, thioglycolic acid, 2-ethylhexyl thioglycolate, and 2,3-dimercapto-1-propanol.

The chain transfer agents may be used alone or in combination thereof.

The usage amount of the chain transfer agent is preferably 0.1 part by weight or less with respect to 100 parts by weight of all monomers.

Examples of the emulsifier to be used in the emulsion polymerization include: anionic emulsifiers, such as sodium lauryl sulfate, ammonium lauryl sulfate, sodium dodecylbenzene sulfonate, an ammonium polyoxyethylene alkyl ether sulfate, a sodium polyoxyethylene alkyl ether sulfate, and a sodium polyoxyethylene alkyl phenyl ether sulfate; and nonionic emulsifiers, such as a polyoxyethylene alkyl ether, a polyoxyethylene alkyl phenyl ether, a polyoxyethylene fatty acid ester, and a polyoxyethylene-polyoxypropylene block polymer.

The emulsifiers may be used alone or in combination thereof.

The usage amount of the emulsifier is preferably from 0.3 part by weight to 5 parts by weight, more preferably from 0.5 part by weight to 1 part by weight with respect to 100 parts by weight of all monomers.

The acrylic pressure-sensitive adhesive may contain a cross-linking agent in addition to the base polymer. Examples of such cross-linking agent include a polyvalent isocyanurate compound, a polyfunctional isocyanate compound, a polyfunctional melamine compound, a polyfunctional epoxy compound, a polyfunctional oxazoline compound, a polyfunctional aziridine compound, and a metal chelate compound. Any appropriate compound may be adopted as a more specific compound serving as such cross-linking agent to the extent that the effect of the present invention is not impaired. Any appropriate usage amount may be adopted as the usage amount of such cross-linking agent to the extent that the effect of the present invention is not impaired. Such cross-linking agents may be used alone or in combination thereof.

An example of the polyvalent isocyanurate compound is a polyisocyanurate compound of hexamethylene diisocyanate. A commercially available product may be used as the polyvalent isocyanurate compound, and specific examples thereof include a product available under the product name “DURANATE TPA-100” (manufactured by Asahi Kasei Chemicals Corporation), and products available under the product names “CORONATE HK”, “CORONATE HX”, and “CORONATE 2096” (manufactured by Tosoh Corporation).

The polyfunctional isocyanate compound is a compound having at least two or more isocyanate groups (preferably three or more isocyanate groups) in the molecule, and specific examples thereof include aliphatic polyisocyanates, alicyclic polyisocyanates, and aromatic polyisocyanates.

Examples of the aliphatic polyisocyanates include: 1,2-ethylene diisocyanate; tetramethylene diisocyanates, such as 1,2-tetramethylene diisocyanate, 1,3-tetramethylene diisocyanate, and 1,4-tetramethylene diisocyanate; hexamethylene diisocyanates, such as 1,2-hexamethylene diisocyanate, 1,3-hexamethylene diisocyanate, 1,4-hexamethylene diisocyanate, 1,5-hexamethylene diisocyanate, 1,6-hexamethylene diisocyanate, and 2,5-hexamethylene diisocyanate; 2-methyl-1,5-pentane diisocyanate; 3-methyl-1,5-pentane diisocyanate; and lysine diisocyanate.

Examples of the alicyclic polyisocyanates include: isophorone diisocyanate; cyclohexyl diisocyanates, such as 1,2-cyclohexyl diisocyanate, 1,3-cyclohexyl diisocyanate, and 1,4-cyclohexyl diisocyanate; cyclopentyl diisocyanates, such as 1,2-cyclopentyl diisocyanate and 1,3-cyclopentyl diisocyanate; hydrogenated xylylene diisocyanate; hydrogenated tolylene diisocyanate; hydrogenated diphenylmethane diisocyanate; hydrogenated tetramethylxylene diisocyanate; and 4,4′-dicyclohexylmethane diisocyanate.

Examples of the aromatic polyisocyanates include 2,4-tolylene diisocyanate, 2,6-tolylene diisocyanate, 4,4′-diphenylmethane diisocyanate, 2,4′-diphenylmethane diisocyanate, 2,2′-diphenylmethane diisocyanate, 4,4′-diphenyl ether diisocyanate, 2-nitrodiphenyl-4,4′-diisocyanate, 2,2′-diphenylpropane-4,4′-diisocyanate, 3,3′-dimethyldiphenylmethane-4,4′-diisocyanate, 4,4′-diphenylpropane diisocyanate, m-phenylene diisocyanate, p-phenylene diisocyanate, naphthylene-1,4-diisocyanate, naphthylene-1,5-diisocyanate, 3,3′-dimethoxydiphenyl-4,4′-diisocyanate, xylylene-1,4-diisocyanate, and xylylene-1,3-diisocyanate.

As the polyfunctional isocyanate compound, dimers or trimers produced from aromatic/aliphatic polyisocyanates may be used in addition to the aliphatic polyisocyanates, the alicyclic polyisocyanates, and the aromatic polyisocyanates. Specific examples thereof include: a dimer or a trimer of diphenylmethane diisocyanate; a reaction product of trimethylolpropane and tolylene diisocyanate; a reaction product of trimethylolpropane and hexamethylene diisocyanate; and polymers such as polymethylene polyphenyl isocyanate, polyether polyisocyanate, and polyester polyisocyanate.

As the polyfunctional isocyanate compound, commercially available products may be used, and specific examples thereof include a product available under the product name “CORONATE L” (manufactured by Tosoh Corporation) serving as a trimer adduct of trimethylolpropane and tolylene diisocyanate, and a product available under the product name “CORONATE HL” (manufactured by Tosoh Corporation) serving as a trimer adduct of trimethylolpropane and hexamethylene diisocyanate.

Examples of the polyfunctional melamine compound include methylated methylol melamine and butylated hexamethylol melamine.

Examples of the polyfunctional epoxy compound include diglycidyl aniline and glycerin diglycidyl ether.

The kind and usage amount of the cross-linking agent are preferably selected so that the gel fraction of the formed pressure-sensitive adhesive layer may be preferably from 30 wt % to 98 wt %, more preferably from 35 wt % to 95 wt %. When the gel fraction of the formed pressure-sensitive adhesive layer is less than 30 wt %, there is a risk in that a sufficient retaining strength (cohesiveness) may not be obtained. When the gel fraction of the formed pressure-sensitive adhesive layer is more than 98 wt %, there is a risk in that a cross-link density may be increased to make it difficult to obtain a high adhesive strength (pressure-sensitive adhesive strength).

The usage amount of the cross-linking agent is, for example, preferably from 0.01 part by weight to 10 parts by weight, more preferably from 0.02 part by weight to 5 parts by weight with respect to 100 parts by weight of the acrylic polymer. When the usage amount of the cross-linking agent is less than 0.01 part by weight with respect to 100 parts by weight of the acrylic polymer, there is a risk in that the retaining strength (cohesive strength) of the pressure-sensitive adhesive layer cannot be enhanced, resulting in a reduction in heat resistance or the like. When the usage amount of the cross-linking agent is more than 10 parts by weight with respect to 100 parts by weight of the acrylic polymer, there is a risk in that the cross-linking reaction may proceed to such a degree as to cause a reduction in adhesive strength.

The acrylic pressure-sensitive adhesive may contain a tackifier. Examples of such tackifier include a terpene-based tackifier, a terpene phenol-based tackifier, a rosin-based tackifier, and a styrene-based tackifier (e.g., a styrene resin and poly(α-methylstyrene)). Of those, a rosin-based tackifier is preferred. Any appropriate usage amount may be adopted as the usage amount of such tackifier to the extent that the effect of the present invention is not impaired. Such usage amount of the tackifier is preferably from 5 parts by weight to 50 parts by weight, more preferably from 10 parts by weight to 30 parts by weight with respect to 100 parts by weight of the base polymer. Such tackifiers may be used alone or in combination thereof.

Examples of the rosin-based tackifier include: modified rosins each obtained by modifying an unmodified rosin (raw rosin), such as a gum rosin, a wood rosin, or a tall oil rosin, through disproportionation or polymerization (e.g., a disproportionated rosin, a polymerized rosin, and other chemically modified rosins); and various rosin derivatives.

Examples of the rosin derivatives include: rosin esters, such as a rosin ester obtained by esterifying an unmodified rosin with an alcohol, and a modified rosin ester obtained by esterifying a modified rosin (e.g., a hydrogenated rosin, a disproportionated rosin, or a polymerized rosin) with an alcohol; unsaturated fatty acid-modified rosins each obtained by modifying an unmodified rosin or a modified rosin (e.g., a hydrogenated rosin, a disproportionated rosin, or a polymerized rosin) with an unsaturated fatty acid; unsaturated fatty acid-modified rosin esters each obtained by modifying a rosin ester with an unsaturated fatty acid; rosin alcohols each obtained by subjecting a carboxy group of an unmodified rosin or a modified rosin (e.g., a hydrogenated rosin, a disproportionated rosin, or a polymerized rosin), an unsaturated fatty acid-modified rosin, or an unsaturated fatty acid-modified rosin ester to reduction treatment; and metal salts of rosins (in particular, a rosin ester), such as an unmodified rosin, a modified rosin, and various rosin derivatives. Examples of the rosin derivatives also include rosin phenol resins each obtained by adding phenol to a rosin (e.g., an unmodified rosin, a modified rosin, or various rosin derivatives) with an acid catalyst, followed by heat polymerization.

Examples of the alcohol to be used for obtaining the rosin ester include: dihydric alcohols, such as ethylene glycol, diethylene glycol, propylene glycol, and neopentyl glycol; trihydric alcohols, such as glycerin, trimethylolethane, and trimethylolpropane; tetrahydric alcohols, such as pentaerythritol and diglycerin; and hexahydric alcohols, such as dipentaerythritol.

The rosin-based tackifier is preferably a modified rosin ester, more preferably a polymerized rosin ester (polymerized rosin esterified with an alcohol).

A commercially available product may be used as the tackifier. Examples of the polymerized rosin ester include PENSEL D-125 (manufactured by Arakawa Chemical Industries Ltd.), PENSEL D-135 (manufactured by Arakawa Chemical Industries Ltd.), PENSEL D-160 (manufactured by Arakawa Chemical Industries Ltd.), SUPER ESTER E-650 (manufactured by Arakawa Chemical Industries Ltd.), SUPER ESTER E-788 (manufactured by Arakawa Chemical Industries Ltd.), SUPER ESTER E-786-60 (manufactured by Arakawa Chemical Industries Ltd.), SUPER ESTER E-865 (manufactured by Arakawa Chemical Industries Ltd.), SUPER ESTER E-865NT (manufactured by Arakawa Chemical Industries Ltd.), HARIESTERSK-508 (manufactured by Harima Chemicals, Inc.), HARIESTER SK-508H (manufactured by Harima Chemicals, Inc.), HARIESTER SK-816E (manufactured by Harima Chemicals, Inc.), HARIESTER SK-822E (manufactured by Harima Chemicals, Inc.), and HARIESTER SK-323NS (manufactured by Harima Chemicals, Inc.).

The tackifier has a softening temperature of preferably 80° C. or more, more preferably 90° C. or more, still more preferably 100° C. or more, particularly preferably 110° C. or more, most preferably 120° C. or more. In addition, from the viewpoint of preventing a reduction in initial adhesive strength, the tackifier has a softening temperature of preferably 160° C. or less, more preferably 150° C. or less. The term “softening temperature” as used herein refers to a ring-and-ball softening temperature Ts measured in conformity with a JIS-K-2207 ring-and-ball softening point (temperature) testing method through the use of a constant load capillary extrusion rheometer (Shimadzu flow tester CFT-500D), and refers to a value measured under the conditions of a die measuring 1 mm×1 mm, a load of 4.9 N, and a rate of temperature increase of 5° C./min.

In one embodiment, the acrylic pressure-sensitive adhesive is a so-called “water-dispersed acrylic pressure-sensitive adhesive,” which is a dispersion liquid in which an acrylic polymer produced by emulsion polymerization is dispersed as a dispersoid in an aqueous medium after the emulsion polymerization. Such water-dispersed acrylic pressure-sensitive adhesive may contain an emulsion-type tackifier (i.e., a dispersion liquid in which a tackifier (resin component) is dispersed as a dispersoid in an aqueous medium). The emulsion-type tackifier is preferably an emulsion-type rosin-based tackifier.

The acrylic pressure-sensitive adhesive may contain any appropriate other component to the extent that the effect of the present invention is not impaired. Examples of such other component include a stabilizer, a filler, a colorant, a UV absorber, and an antioxidant. Such other components may be used alone or in combination thereof.

### (Silicone-Based Pressure-Sensitive Adhesive)

Any appropriate silicone-based pressure-sensitive adhesive may be adopted as the silicone-based pressure-sensitive adhesive to the extent that the effect of the present invention is not impaired. Examples of such silicone-based pressure-sensitive adhesive include an addition-type silicone-based pressure-sensitive adhesive, a peroxide-curable silicone-based pressure-sensitive adhesive, and a condensation-type silicone-based pressure-sensitive adhesive. Examples of the silicone-based pressure-sensitive adhesive include a one-component silicone-based pressure-sensitive adhesive and a two-component silicone-based pressure-sensitive adhesive. The silicone-based pressure-sensitive adhesives may be used alone or in combination thereof.

An example of the silicone-based pressure-sensitive adhesive is a silicone-based pressure-sensitive adhesive formed of a composition containing 100 parts by weight of a peroxide-curable silicone resin, 1.2 parts by weight to 3.2 parts by weight of an organic peroxide curing agent, and 2 parts by weight to 9 parts by weight of an addition reaction-curable silicone rubber. This composition can particularly exhibit excellent load durability even under a high-temperature environment, for example, under an environment of more than 200° C.

The peroxide-curable silicone resins may be used alone or in combination thereof.

The peroxide-curable silicone resin contains a peroxide-curable silicone rubber and/or a partial condensate thereof. The silicone rubber may be a crude rubber (gum). The peroxide-curable silicone resin may contain at least one kind selected from a silicone resin and a partial condensate thereof. Any appropriate composition may be adopted as the composition of the peroxide-curable silicone resin as long as the composition contains the peroxide-curable silicone rubber and/or the partial condensate thereof.

An example of the peroxide-curable silicone rubber is an organopolysiloxane having dimethylsiloxane as a main constituent unit. The organopolysiloxane may have introduced therein a hydroxy group or any other functional group as required. A specific example of the organopolysiloxane is dimethylpolysiloxane. The weight-average molecular weight of the organopolysiloxane is preferably 180,000 or more, more preferably from 280,000 to 1,000,000, still more preferably from 500,000 to 900,000. The peroxide-curable silicone resin may contain two or more kinds of peroxide-curable silicone rubbers. The peroxide-curable silicone resin may contain two or more kinds of partial condensates of peroxide-curable silicone rubbers.

An example of the silicone resin is an organopolysiloxane having at least one kind of unit selected from an M unit (R₃SiO_{1/2}), a Q unit (SiO₂), a T unit (RSiO_{3/2}), and a D unit (R₂SiO). Rs in those units each independently represent a monovalent hydrocarbon group or a hydroxy group. The silicone resin may have introduced therein a functional group as required, and the introduced functional group may be one that causes a cross-linking reaction. The silicone resin is preferably a so-called MQ resin, which is constituted of the M unit and the Q unit.

When the silicone resin is the MQ resin, a molar ratio between the content of the M unit and the content of the Q unit is, for example, preferably from 0.3:1 to 1.5:1, more preferably from 0.5:1 to 1.3:1, expressed as M unit:Q unit.

The peroxide-curable silicone resin may contain two or more kinds of silicone resins. The peroxide-curable silicone resin may contain two or more kinds of partial condensates of silicone resins.

When the peroxide-curable silicone resin contains the silicone resin, a weight ratio between the silicone rubber and the silicone resin is, for example, preferably from 100:110 to 100:220, more preferably from 100:160 to 100:190, expressed as silicone rubber:silicone resin. When the peroxide-curable silicone resin contains the partial condensate of the silicone rubber and/or the partial condensate of the silicone resin, it is appropriate that the weight ratio between the silicone rubber and the silicone resin be determined from the weights of the silicone rubber and silicone resin before partial condensation.

Examples of the organic peroxide curing agent include benzoyl peroxide, t-butyl peroxybenzoate, dicumyl peroxide, t-butyl cumyl peroxide, di-t-butyl peroxide, 2,5-dimethyl-2,5-di(t-butylperoxy)hexane, 2,4-dichlorobenzoyl peroxide, 1,1-bis(t-butylperoxy)-3,3,5-trimethylcyclohexane, and 2,5-dimethyl-2,5-di(t-butylperoxy)hexyne-3.

The organic peroxide curing agents may be used alone or in combination thereof.

The amount of the organic peroxide curing agent that may be contained in the silicone-based pressure-sensitive adhesive is preferably from 1.2 parts by weight to 3.2 parts by weight, more preferably from 1.4 parts by weight to 3.0 parts by weight with respect to 100 parts by weight of the peroxide-curable silicone resin. When the amount of the organic peroxide curing agent that may be contained in the silicone-based pressure-sensitive adhesive is less than 1.2 parts by weight with respect to 100 parts by weight of the peroxide-curable silicone resin, there is a risk in that the adhesive strength of the silicone-based pressure-sensitive adhesive may be insufficient. When the amount of the organic peroxide curing agent that may be contained in the silicone-based pressure-sensitive adhesive is more than 3.2 parts by weight with respect to 100 parts by weight of the peroxide-curable silicone resin, there is a risk in that the load durability under a high-temperature environment may be reduced.

The number of kinds of addition reaction-curable silicone rubbers that may be contained in the silicone-based pressure-sensitive adhesive may be only one, or may be two or more.

The addition reaction-curable silicone rubber may be a crude rubber (gum). Any appropriate addition reaction-curable silicone rubber may be adopted as the addition reaction-curable silicone rubber. The addition reaction-curable silicone rubber contains an addition-polymerizable group. Such addition-polymerizable group is, for example, a vinyl group.

The amount of the addition reaction-curable silicone rubber is preferably from 2 parts by weight to 9 parts by weight, more preferably from 3 parts by weight to 7 parts by weight with respect to 100 parts by weight of the peroxide-curable silicone resin. When the amount of the addition reaction-curable silicone rubber falls within this range, a silicone pressure-sensitive adhesive that exhibits excellent load durability even under a high-temperature environment can be provided.

When the addition reaction-curable silicone rubber is cured, the modulus of elasticity (storage modulus of elasticity G′) of the resultant is preferably 0.01 MPa or more and 1 MPa or less at room temperature (25° C.), and 0.01 MPa or more and 1 MPa or less at 200° C. Such modulus of elasticity is more preferably 0.1 MPa or more and 1 MPa or less at room temperature, and 0.1 MPa or more and 1 MPa or less at 200° C. The storage modulus of elasticity G′ may be measured with a rheometer. As a specific example of a measurement method, a measurement object is, for example, formed or laminated so as to have a thickness of about 1.5 mm, and is then subjected to measurement in the temperature range of from −20° C. to 250° C. using a rheometer (e.g., Advanced Rheometric Expansion System (ARES) manufactured by Rheometric Scientific) under the measurement conditions of a shear mode, a frequency of 1 Hz, and a rate of temperature increase of 5° C./min.

As required, the silicone-based pressure-sensitive adhesive may contain other components, such as an additive, a catalyst, a cross-linking agent, and a solvent for adjusting the viscosity of the pressure-sensitive adhesive. An example of the catalyst is a platinum catalyst. An example of the cross-linking agent is a siloxane-based cross-linking agent having a SiH group.

The gel fraction of the silicone-based pressure-sensitive adhesive after its curing (gel fraction in its cured product) is preferably from 40 wt % to 60 wt %, more preferably from 45 wt % to 55 wt %. The gel fraction of the silicone-based pressure-sensitive adhesive after its curing may be determined, for example, by immersion involving dissolving components other than a gel in the silicone-based pressure-sensitive adhesive as described below.

About 0.1 g of the silicone-based pressure-sensitive adhesive after its curing, for example, the formed pressure-sensitive adhesive layer is wrapped in a porous polytetrafluoroethylene (PTFE) sheet having an average pore diameter of 0.2 μm (e.g., NTF1122, manufactured by Nitto Denko Corporation), and then the resultant is tied with a kite string to produce a measurement sample. Next, the weight of the produced measurement sample is measured, and this weight is defined as a pre-immersion weight C. The pre-immersion weight C is the total weight of the pressure-sensitive adhesive layer, the polytetrafluoroethylene sheet, and the kite string. Separately, the total weight of the PTFE sheet and the kite string is measured in advance, and is defined as a wrapper weight B. Next, the measurement sample is placed in a container having an internal volume of 50 mL filled with toluene, and the whole is left to stand still at 23° C. for 7 days. Next, the inside of the container including the measurement sample is washed with ethyl acetate, and then the measurement sample is removed from the container and transferred to a cup made of aluminum, followed by drying at 130° C. for 2 hours to remove ethyl acetate. Next, the weight of the measurement sample from which ethyl acetate has been removed is measured, and this weight is defined as a post-immersion weight A. The gel fraction may be determined from the following equation.

Gel fraction (wt %)=(A−B)/(C−B)×100

The silicone-based pressure-sensitive adhesive may be produced by, for example, mixing the peroxide-curable silicone resin, the organic peroxide curing agent, and the addition reaction-curable silicone rubber. Any appropriate order may be adopted as the order in which the components are mixed. In the mixing, any appropriate other component may be added as required.

### (Rubber-Based Pressure-Sensitive Adhesive)

The rubber-based pressure-sensitive adhesive contains a rubber-based polymer as a base polymer, and encompasses one in which the base polymer is a natural rubber (NR), one in which the base polymer is a modified natural rubber, and one in which the base polymer is a synthetic rubber.

As the modified natural rubber, there may be preferably adopted a modified natural rubber containing 50 wt % or more (preferably 60 wt % or more) of a structural portion derived from a natural rubber. An example of the modified natural rubber is a graft-modified natural rubber obtained by grafting another monomer onto the natural rubber. Examples of the monomer to be grafted onto the natural rubber include an acrylic monomer and styrene. The graft-modified natural rubber is preferably an acrylic-modified natural rubber in which the monomer to be grafted has 50 wt % or more of an acrylic monomer (preferably a monomer having an acryloyl group or a methacryloyl group). In the acrylic-modified natural rubber, examples of the acrylic monomer to be grafted onto the natural rubber include: (meth)acrylic acid; and alkyl (meth)acrylates each including an alkyl group having 1 to 16 carbon atoms, such as methyl (meth)acrylate, ethyl (meth)acrylate, isopropyl (meth)acrylate, and t-butyl (meth)acrylate. Of those, methyl methacrylate, ethyl methacrylate, isopropyl methacrylate, and t-butyl methacrylate are preferred. The acrylic monomers may be used alone or in combination thereof.

Examples of the synthetic rubber include polybutadiene, polyisoprene, a butyl rubber, polyisobutylene, a styrene-butadiene rubber (SBR), a styrene-butadiene-styrene block copolymer (SBS), a styrene-ethylene-butylene-styrene block copolymer (SEBS), and a styrene-isoprene-styrene block copolymer (SIS).

In one embodiment, the rubber-based pressure-sensitive adhesive is a rubber-based pressure-sensitive adhesive in which the base polymer is a natural rubber. Such natural rubber is preferably, for example, a natural rubber having a Mooney viscosity of from 10 to 60 under the measurement conditions of MS(1+4100°) C. (using an L-type rotor, preheating: 1 minute, viscosity measurement time: 4 minutes, test temperature: 100° C.)

In another embodiment, the rubber-based pressure-sensitive adhesive is a rubber-based pressure-sensitive adhesive in which the base polymer is an acrylic-modified natural rubber (NR-MMA graft copolymer) obtained by grafting methyl methacrylate onto a natural rubber. Such acrylic-modified natural rubber (NR-MMA graft copolymer) may be produced by any appropriate method, or may be easily obtained as a commercially available product. The graft ratio of methyl methacrylate in the acrylic-modified natural rubber (NR-MMA graft copolymer) is preferably from 1% to 120%, more preferably from 5% to 100%, still more preferably from 10% to 90%, particularly preferably from 30% to 80%. The graft ratio of methyl methacrylate in the acrylic-modified natural rubber (NR-MMA graft copolymer) is expressed by (weight of methyl methacrylate bonded to natural rubber/weight of natural rubber used in grafting)×100(%), and is generally equivalent to a value calculated from a weight ratio between the natural rubber and methyl methacrylate used at the time of the production of the acrylic-modified natural rubber (NR-MMA graft copolymer).

The rubber-based pressure-sensitive adhesive may have composition obtained by blending the base polymer with another polymer (hereinafter also referred to as auxiliary polymer). Examples of the auxiliary polymer include an acrylic polymer that may serve as a base polymer of an acrylic pressure-sensitive adhesive, a polyester-based polymer that may serve as a base polymer of a polyester-based pressure-sensitive adhesive, a polyurethane-based polymer that may serve as a base polymer of a polyurethane-based pressure-sensitive adhesive, a silicone polymer that may serve as a base polymer of a silicone-based pressure-sensitive adhesive, and polymers other than a base polymer of a rubber-based polymer. The auxiliary polymers may be used alone or in combination thereof.

The usage amount of the auxiliary polymer is preferably 100 parts by weight or less, more preferably 70 parts by weight or less, still more preferably 50 parts by weight or less with respect to 100 parts by weight of the base polymer.

The rubber-based pressure-sensitive adhesive may contain a tackifier. Examples of the kind of the tackifier include those described in the “(Acrylic Pressure-sensitive Adhesive)” section, a petroleum-based resin (e.g., a C5-based or C9-based resin), and a ketone-based resin. The tackifiers may be used alone or in combination thereof.

Examples of the petroleum-based resin include an aliphatic petroleum resin, an aromatic petroleum resin, a copolymer-based petroleum resin, an alicyclic petroleum resin, and hydrogenated products thereof.

An example of the ketone-based resin is a ketone-based resin obtained by condensation of a ketone and formaldehyde.

The tackifier may be suitably used in, for example, an embodiment in which the base polymer is a natural rubber or a modified natural rubber. Preferred examples of the tackifier include a rosin-based resin, a rosin derivative resin, an aliphatic (C5-based) petroleum resin, and a terpene resin.

The usage amount of the tackifier is preferably from 20 parts by weight to 150 parts by weight, more preferably from 30 parts by weight to 100 parts by weight with respect to 100 parts by weight of the base polymer.

The rubber-based pressure-sensitive adhesive may contain a vulcanization accelerator. Examples of such vulcanization accelerator include zinc oxide, dithiocarbamic acids (e.g., sodium dimethyldithiocarbamate, sodium diethyldithiocarbamate, zinc dimethyldithiocarbamate, and zinc diethyldithiocarbamate), thiazoles (e.g., 2-mercaptobenzothiazole and dibenzothiazyl disulfide), guanidines (diphenylguanidine and di-o-tolylguanidine), sulfenamides (e.g., benzothiazyl-2-diethylsulfenamide and N-cyclohexyl-2-benzothiazylsulfenamide), thiurams (e.g., tetramethylthiuram monosulfide and tetramethylthiuram disulfide), xanthogenic acids (e.g., sodium isopropyl xanthate and zinc isopropyl xanthate), aldehyde ammonias (e.g., acetaldehyde ammonia and hexamethylenetetramine), aldehyde amines (e.g., n-butyl aldehyde aniline and butyl aldehyde monobutyl amine), and thioureas (e.g., diethylthiourea and trimethylthiourea). Such vulcanization accelerators may be used alone or in combination thereof. The usage amount of the vulcanization accelerator is preferably from 0.1 part by weight to 10 parts by weight, more preferably from 0.5 part by weight to 5 parts by weight with respect to 100 parts by weight of the base polymer component.

The rubber-based pressure-sensitive adhesive may contain a cross-linking agent as required. Examples of such cross-linking agent include an isocyanate compound, sulfur, a sulfur-containing compound, a phenol resin, and an organometallic compound. Of those, an isocyanate compound is preferred. Specific examples of the isocyanate compound include those described in the “(Acrylic Pressure-sensitive Adhesive)” section. The usage amount of the isocyanate compound is preferably from 0.3 part by weight to 10 parts by weight, more preferably from 0.5 part by weight to 5 parts by weight with respect to 100 parts by weight of the base polymer component.

Any appropriate additive may be blended into the rubber-based pressure-sensitive adhesive as required. Examples of such additive include a softener, a flame retardant, an antistatic agent, a colorant (e.g., a pigment or a dye), a light stabilizer (e.g., a radical scavenger or a UV absorber), and an antioxidant.

### <Release Liner>

The surface of the first pressure-sensitive adhesive layer and/or the second pressure-sensitive adhesive layer may be protected with a release liner until actual use. The release liner may be used as a support when the pressure-sensitive adhesive layer is formed by applying a solution or dispersion liquid in which a pressure-sensitive adhesive is dissolved or dispersed in an organic liquid medium or an aqueous liquid medium to one surface of the support in the form of a layer, and heating the resultant to dry and remove the organic liquid medium or the aqueous liquid medium.

Examples of a material for forming the release liner include any appropriate thin materials, such as: plastic films, such as a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, an ethylene-vinyl acetate copolymer film, and a polyester film; porous materials, such as paper, a fabric, and a non-woven fabric; nets; foam sheets; metallic foils; and laminates thereof. Of those release liners, a plastic film is preferred because of its excellent surface smoothness.

The thickness of the release liner is preferably from 5 μm to 200 μm, more preferably from 5 μm to 100 μm.

As required, the release liner may be subjected to: release treatment and antifouling treatment with, for example, a silicone-based release agent, a fluorine-based release agent, a long-chain alkyl-based release agent, a fatty acid amide-based release agent, or silica powder; antistatic treatment, such as application-type antistatic treatment, kneading-type antistatic treatment, or vapor deposition-type antistatic treatment; or the like.

### <<Method of Producing Pressure-Sensitive Adhesive Tape>>

Any appropriate method may be adopted as a method of producing the pressure-sensitive adhesive tape as long as the method allows the pressure-sensitive adhesive tape to be produced so as to include the first pressure-sensitive adhesive layer, the intermediate layer, and the second pressure-sensitive adhesive layer in the stated order and to the extent that the effect of the present invention is not impaired.

A case in which the pressure-sensitive adhesive tape to be produced is such pressure-sensitive adhesive tape as illustrated in FIG. 3, FIG. 4, or FIG. 5 is described as a typical example. For example, the first pressure-sensitive adhesive layer is formed on a first release liner (laminate A of [first pressure-sensitive adhesive layer]/[first release liner]), the second pressure-sensitive adhesive layer is formed on a second release liner (laminate B of [second pressure-sensitive adhesive layer]/[second release liner]), the intermediate layer is formed on the base material layer by printing (laminate C of [base material layer]/[intermediate layer]), the first pressure-sensitive adhesive layer side of the laminate A of [first pressure-sensitive adhesive layer]/[first release liner] is bonded to the intermediate layer side of the laminate C of [base material layer]/[intermediate layer], the second pressure-sensitive adhesive layer side of the laminate B of [second pressure-sensitive adhesive layer]/[second release liner] is bonded to the base material layer side of the laminate C of [base material layer]/[intermediate layer], and as required, aging is performed. Thus, a laminate D of [first release liner]/[first pressure-sensitive adhesive layer]/[intermediate layer]/[base material layer]/[second pressure-sensitive adhesive layer]/[second release liner] may be produced. At the time of the use of the laminate D, such pressure-sensitive adhesive tape as illustrated in FIG. 3, FIG. 4, or FIG. 5 is provided by peeling off the first release liner and the second release liner.

Now, the present invention is described specifically by way of Examples. However, the present invention is by no means limited to Examples. Test and evaluation methods in Examples and the like are as described below. The term “part(s)” in the following description means “part(s) by weight” unless otherwise specified, and the term “%” in the following description means “wt %” unless otherwise specified.

### <Leakage Property Evaluation>

### (Preparation of Frame-Shaped Tape Sample)

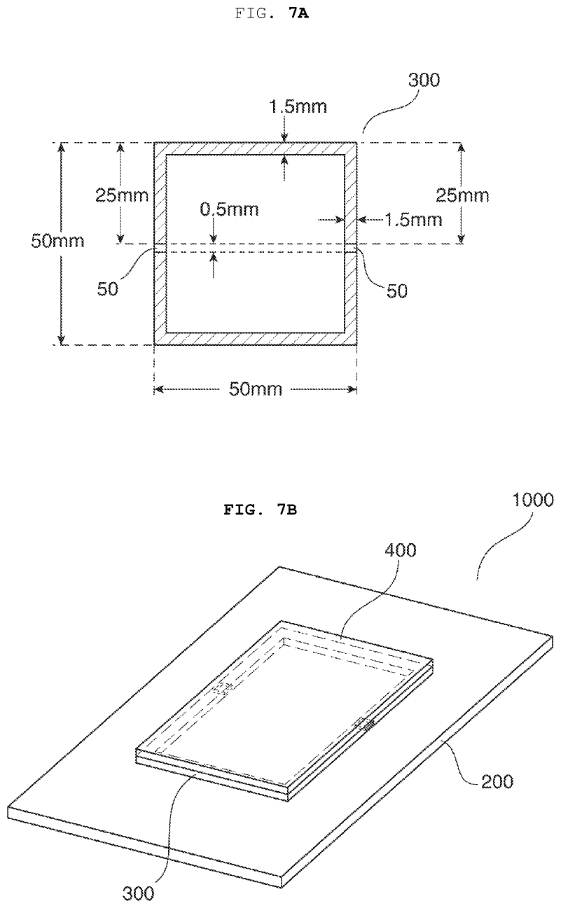

As illustrated in FIG. 7A, a pressure-sensitive adhesive tape obtained in Example was shaped into a frame-shaped tape sample having a width of 1.5 mm and measuring 50 mm square. A through-hole was arranged at a position 25 mm away from a corner portion. A tape obtained in Comparative Example was similarly shaped into a frame-shaped tape sample having a width of 1.5 mm and measuring 50 mm square.

As illustrated in FIG. 7B, a frame-shaped tape sample 300 was bonded onto a SUS plate 200, and a PET #25 plate (manufactured by Toray Industries, Inc., S-10) 400 was bonded thereonto to produce an evaluation sample 1000.

The produced evaluation sample was stored under an environment having a temperature of 60° C. for 24 hours, removed therefrom, and left to stand under an environment having a temperature of 23° C. for 30 minutes. After that, the presence or absence of swelling of the PET #25 plate was observed, and evaluation was performed by the following criteria.

Swelling was observed (the leakage property was poor, resulting in an increase in internal pressure): x

Swelling was not observed (the leakage property was satisfactory, resulting in the suppression of an increase in internal pressure): ∘

### Production Example 1

### (Production of Laminate (1))

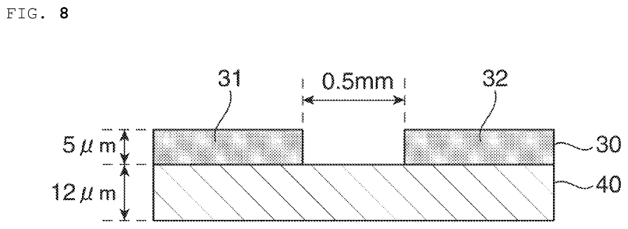

A material for forming an intermediate layer (urethane-based: two-component mixing curable ink) was applied by gravure printing to one surface of a polyester resin film having a thickness of 12 μm to provide a laminate (1) in which, as illustrated in FIG. 8, the intermediate layer 30 having a thickness of 5 μm (the first portion 31 and the second portion 32 forming a pattern having a spacing of 0.5 mm) was arranged on the base material layer 40 having a thickness of 12 μm.

### Production Example 2

### (Production of Laminate (2))

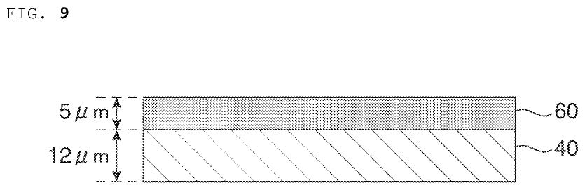

A material for forming an intermediate layer (urethane-based: two-component mixing curable ink) was applied by gravure printing to one surface of a polyester resin film having a thickness of 12 μm to provide a laminate (2) in which, as illustrated in FIG. 9, the printed layer 60 having a thickness of 5 μm was arranged on the base material layer 40 having a thickness of 12 μm.

### Example 1

A reaction vessel with a stirrer, a thermometer, a nitrogen gas inlet tube, a reflux condenser, and a dropping funnel was loaded with 70 parts of butyl acrylate (BA), 27 parts of 2-ethylhexyl acrylate (2-EHA), 3 parts of acrylic acid (AA), and 0.05 part of 4-hydroxybutyl acrylate serving as monomer components, and was loaded with 135 parts of toluene serving as a polymerization solvent. While a nitrogen gas was introduced, the contents were stirred for 2 hours. Thus, oxygen in the polymerization system was removed. After that, 0.1 part of 2,2′-azobisisobutyronitrile (AIBN) was added as a polymerization initiator, and solution polymerization was performed at 60° C. for 6 hours to provide a toluene solution of an acrylic polymer. The acrylic polymer had a weight-average molecular weight (Mw) of 40×10⁴.

To the resultant toluene solution of the acrylic polymer, 30 parts of a polymerized rosin ester (product name: “PENSEL D-125”, softening point: 120° C. to 130° C., manufactured by Arakawa Chemical Industries, Ltd.) serving as a tackifying resin, and 2 parts of an isocyanate-based cross-linking agent (product name: “CORONATE L”, manufactured by Tosoh Corporation, solid content: 75%) were added with respect to 100 parts of the acrylic polymer contained in the toluene solution to prepare an acrylic pressure-sensitive adhesive composition (1).

Two commercially available release liners (product name: “DIAFOIL MRF”, thickness: 38 μm, manufactured by Mitsubishi Polyester Film, Inc.) were prepared, and the acrylic pressure-sensitive adhesive composition (1) was applied to one surface (release surface) of each of the release liners so as to have a thickness of 16 μm after drying, followed by drying at 100° C. for 2 minutes. Thus, a pressure-sensitive adhesive layer was formed on the release surface of each of the two release liners.

The pressure-sensitive adhesive layers formed on the two release liners were respectively bonded to both surfaces of the laminate (1) obtained in Production Example 1, and the resultant was aged in an oven at 50° C. for 1 day. Thus, a pressure-sensitive adhesive tape (1) was obtained.

The lamination configuration of the pressure-sensitive adhesive tape (1) is as follows: [release liner] (thickness: 38 μm)/[pressure-sensitive adhesive layer] (thickness: 16 μm)/[intermediate layer] (thickness: 5 μm)/[base material layer] (thickness: 12 μm)/[pressure-sensitive adhesive layer] (thickness: 16 μm)/[release liner] (thickness: 38 μm).

The pressure-sensitive adhesive tape (1) was subjected to the leakage property evaluation. The result was “∘” because swelling was not observed.

### Comparative Example 1

A tape (C1) was obtained in the same manner as in Example 1 except for using the laminate (2) obtained in Production Example 2 instead of using the laminate (1) obtained in Production Example 1.

The lamination configuration of the tape (C1) is as follows: [release liner] (thickness: 38 μm)/[pressure-sensitive adhesive layer] (thickness: 16 μm)/[printed layer] (thickness: 5 μm)/[base material layer] (thickness: 12 μm)/[pressure-sensitive adhesive layer] (thickness: 16 μm)/[release liner] (thickness: 38 μm).

The tape (C1) was subjected to the leakage property evaluation. The result was “x” because swelling was observed.

### [Result]

It was found that the pressure-sensitive adhesive tape obtained in Example 1 had a satisfactory leakage property and was able to suppress an increase in internal pressure because swelling was not observed in the leakage property evaluation.

The pressure-sensitive adhesive tape of the present invention can prevent an increase in internal pressure when used for, for example, forming a closed space, and is applicable to, for example, bonding of various constituent members of an electronic device.

What is claimed is:

1. A pressure-sensitive adhesive tape, comprising, in this order:
a first pressure-sensitive adhesive layer;
an intermediate layer; and
a second pressure-sensitive adhesive layer,
the pressure-sensitive adhesive tape having at least one through-hole that penetrates through the pressure-sensitive adhesive tape in a plane direction thereof.

2. The pressure-sensitive adhesive tape according to claim 1, wherein the through-hole is arranged so as to penetrate through the pressure-sensitive adhesive tape in a widthwise direction thereof.

3. The pressure-sensitive adhesive tape according to claim 1, wherein the intermediate layer comprises a printed layer formed by printing.

4. The pressure-sensitive adhesive tape according to claim 2, wherein the intermediate layer comprises a printed layer formed by printing.

5. The pressure-sensitive adhesive tape according to claim 3, further comprising a base material layer between the printed layer and the second pressure-sensitive adhesive layer,
wherein the printed layer is laminated with the base material layer, and
wherein the through-hole is defined by a printed pattern of the printed layer, the first pressure-sensitive adhesive layer, and the base material layer.

6. The pressure-sensitive adhesive tape according to claim 4, further comprising a base material layer between the printed layer and the second pressure-sensitive adhesive layer,
wherein the printed layer is laminated with the base material layer, and
wherein the through-hole is defined by a printed pattern of the printed layer, the first pressure-sensitive adhesive layer, and the base material layer.

7. The pressure-sensitive adhesive tape according to claim 1, wherein the intermediate layer has a thickness of from 0.1 μm to 100 μm.

8. The pressure-sensitive adhesive tape according to claim 1, wherein the pressure-sensitive adhesive tape has a total thickness of from 1 μm to 500 μm.
